(19) United States
(12) Patent Application Publication
(10) Pub. No.: US 2004/0062520 A1
(43) Pub. Date: Apr. 1, 2004

(54) Enhanced commercial detection through fusion of video and audio signatures

(75) Inventors: Srininvas Gutta, Yorktown Heights, NY (US); Lalitha Agnihotri, Fishkill, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/259,707

(22) Filed: Sep. 27, 2002

(51) Int. Cl. H04N 5/91; G11B 27/00

(52) U.S. Cl. 386/46; 358/908

(57) ABSTRACT

A system and method for detecting commercials from other programs in a stored content. The system comprises an image detection module that detects and extracts faces in a specific time window. The extracted faces are matched against the detected faces in the subsequent time window. If none of the faces match, a flag is set, indicating a beginning of a commercial portion. A sound or speech analysis module verifies the beginning of the commercial portion by analyzing the sound signatures in the same time windows used for detecting faces.

### FIELD OF THE INVENTION

The invention relates to detecting commercials and particularly to detecting commercials by using both video and audio signatures through successive time windows.

### BACKGROUND OF THE INVENTION

Existing systems that distinguish commercial portions in the television broadcasting signals from other program contents do so by detecting different broadcasting modes or differences in the level of received video signals. For example, U.S. Pat. No. 6,275,646, describes a video recording/reproducing apparatus that discriminates commercial message portions on the basis of the time intervals among a plurality of audio-free portions and the time intervals of the changing points of a plurality of video signals in the television broadcasting. German Patent DE29902245 discloses a television recording apparatus for viewing without advertisements. The methods disclosed in these patents, however, are rule-based and as such rely on fixed features such as the changing points or station logos being present in the video signals. Other commercial detection systems employ close-captioned text or rapid scene change detection techniques to distinguish commercials from other programs. These above-described detection methods would not work if the presence of these features, for example, changing points of video signals, station logos, and close-captioned text were to change. Accordingly, there is a need for detecting commercials in video signals without having to rely on the presence or absence of these features.

### SUMMARY OF THE INVENTION

Television commercials almost always contain images of human beings and other animate or inanimate objects, which for example may be recognized or detected by employing known image or face detection techniques. As many companies and the government alike expand more resources in the research and development of various identification technologies, more sophisticated and reliable image recognition techniques are becoming readily available. With the advent of these sophisticated and reliable image recognition tools, it is thus desirable to have a commercial detection system that utilizes the image recognition tools to more accurately distinguish commercial portions from other broadcasted contents. Further, it is desirable to have a system and method for enhancing the commercial detection by further employing additional techniques such as an audio recognition or signature technique to, for example, verify the detected commercial.

Accordingly, there is provided an enhanced commercial detection system and method that uses fusion of video and audio signatures. In one aspect, the method provided identifies a plurality of video segments in a stored content, the plurality of video segments being in sequential time order. Images from one video segment are compared with images from the next video segment. If the images do not match, sound signatures from the two segments are compared. If the sound signatures do not match, a flag is set indicating a change in a program content, for example, from a regular program to a commercial, or vice versa.

The system provided, in one aspect, comprises an image recognition module for detecting and extracting images from the video segments, a sound signature module for detecting and extracting sound signatures from the same video segments, and a processor that compares the images and the sound signatures to determine commercial portions in a stored content.

### BRIEF DESCRIPTION OF THE DRAWINGS

FIG. 1 illustrates a format of stored program content divided into a plurality of time segments or time windows;

FIG. 2 illustrates a detailed flow diagram for detecting commercials in the stored content in one aspect;

FIG. 3 is a flow diagram illustrating a commercial detection method enhanced with sound signature analysis technique in one aspect;

FIG. 4 is a flow diagram illustrating a commercial detection method enhanced with sound signature analysis technique in another aspect; and

FIG. 5 is a diagram illustrating the components of the commercial detection system in one aspect.

### DETAILED DESCRIPTION

To detect commercials, known face detection techniques may be employed to detect and extract facial images in a specific time window of a stored television program. The extracted facial images may then be compared with those detected in the previous time window or a predetermined number of previous time windows. If none of the facial images match, a flag may be set to indicate a possible start of a commercial.

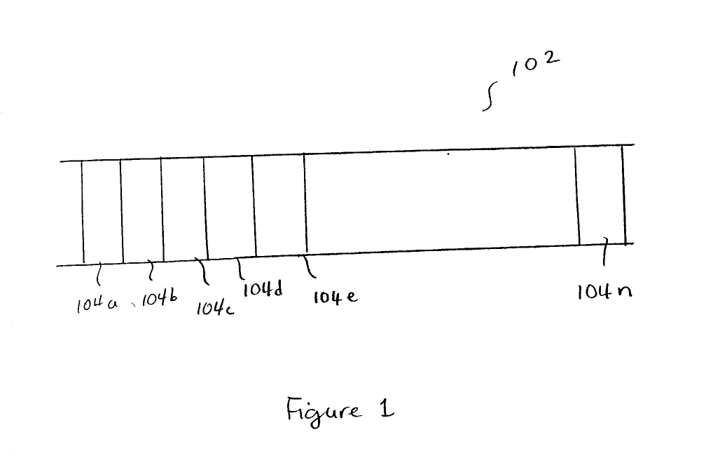

FIG. 1 illustrates a format of stored program content divided into a plurality of time segments or time windows. The stored program content, for example, may be a broadcasted TV program that was video taped on a magnetic tape or any other available storage devices intended for such use. As shown in FIG. 1, the stored program content 102 is divided into a plurality of segments 104a, 104b, . . . 104n of a predetermined time duration. Each segment 104a, 104b, . . . 104n comprises a number of frames. These segments are also referred to herein as time windows, video segments, or time segments.

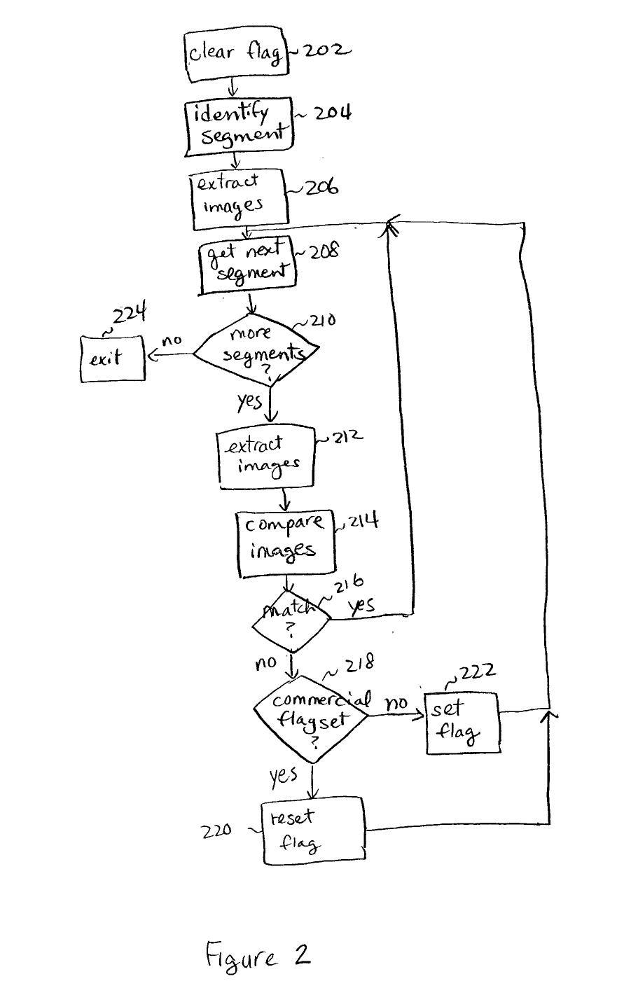

FIG. 2 illustrates a detailed flow diagram for detecting commercials in the stored content in one aspect. As described above, the stored content includes, for example, a television program that has been videotaped or stored. Referring to FIG. 2, at 202 a flag is cleared or initialized. This flag indicates that commercial has not been detected yet in the stored content 102. At 204, a segment or time window (104a FIG. 1) in the stored content is identified for analysis. This segment may be the first segment in the stored content, when detecting commercials from the beginning of the stored program. This segment may also be any other segment in the store content, for example, if a user desires to detect commercials in certain portions of the stored program. In this case, a user would indicate a location in the stored program from where to start the commercial detection.

At 206, a known face detection technique is employed to detect and extract facial images detected in the time window. If no facial images are detected in this time window, a subsequent time window is analyzed, until a time window with facial images is detected. Thus, steps 204 and 206 may be repeated until a time window having one or more facial images is identified. At 208, next segment or time window (104b FIG. 1) is analyzed. At 210, if there is no next segment, that is, if the end of the stored program is encountered, the process exits at 224. Otherwise, at 212, facial images in this time window 104b are also detected and extracted. If no facial images are detected, the process returns to 204. At 214, the facial images detected from the first time window (104a FIG. 1) and the next time window (104b FIG. 1) are compared. At 216, if the facial images match, the process returns to 208, where a subsequent time window (for example, 104c FIG. 1) is identified and analyzed for matching facial images. The facial images are matched or compared with facial images detected in the time window preceding the current time windows. Thus, for example, referring to FIG. 1, the facial images detected in the time window 104a are compared with the facial images in the time window 104b. The facial images detected in the time window 104b are compared with the facial images in the time window 104c, and so forth.

In another aspect, facial images from more than one preceding time window may be compared. For example, facial images detected in the time window 104c may be compared to those detected in time windows 104a and 104b, and if none of the images match, it may be determined that there is a change in the program content. Comparing current window's facial images with those detected in a number of preceding windows may accurately compensate for different images occurring due to scene changes. For example, changes in images in time windows 104b and 104c may occur due to scene changes in a regular program and not necessarily because the time window 104c contains a commercial. Accordingly, if images in the time window 104c were compared also with images in the time window 104a whose content includes a regular program, and if they match, it may be determined that the time window 104c contains a regular program even though images in the time window 104c did not match with those images in the time window 104b. In this way, commercials may be distinguished from scene changes in a regular program from segment to segment.

In one aspect, to compensate for or differentiate scene changes from commercials, at the initialization stage, images from a number of time windows may be accumulated as a base for comparison before beginning the comparison process. For example, referring to FIG. 1, images from the first three windows 104a. 104c may be accumulated initially. These first three windows 104a. 104c are assumed to contain a regular program. Then the images from window 104d may be compared with images from 104c, 104b, and 104a. Next, when processing 104e, the images from window 104e may be compared with images from 104d, 104c, and 104b, thus creating a moving window, for example, of three, for comparison. In this way, erroneous detection of commercials due to scene changes at initialization may be eliminated.

In addition, if a commercial is playing at the initial stage of the recording, the accumulation of a number of time windows will eliminate a possible erroneous determination that the first scene of the program is a commercial.

Referring back to FIG. 2, at 216, if the facial images in the current window do not match, indicating for example that a programming content has changed, that is, from a televised program to a commercial or vice versa, the process proceeds to 218 where it is determined whether a commercial flag is set. The commercial flag being set, for example, indicates that the current time window was a part of a commercial.

The commercial flag would however, be reset, if the same new faces in the program continue to exist for the next n time frames because this means that the scene or the actors changed and the program material continues. The commercials are fairly short (30 seconds to a minute) and this method is used to correct changes in faces that might falsely trigger the presence of a commercial.

If the commercial flag is set, then the changes in the facial images may imply a different commercial or a resuming of a program. Since there are about 3 to 4 commercials grouped together in a segment, new faces occurring for several windows at a stretch would imply that different commercials have started. However, if the changes in the facial images match the faces in the time segment before the commercial flag was set then this would imply that a regular program has resumed. Accordingly, the commercial flag is reset or reinitialized at 220.

On the other hand, if at 218, the commercial flag is not set, the change in the facial images from previous to current time window would mean that a commercial portion has started. Accordingly, at 222, the commercial flag is set. As is known to those skilled in the art of computer programming, setting or resetting of the commercial flag may be achieved by assigning values ‘1 ’ or ‘0’, respectively, in a memory area or register. Setting or resetting of the commercial flag may also be indicated by assigning values “yes” or “no”, respectively, to the memory area designated for the commercial flag. Then the process continues to 208 where subsequent time windows are examined in the same manner to detect commercial portions in the stored program content.

In another aspect, facial images in the video content are tracked and their trajectories are mapped along with their identification. Identification, for example, may include identifiers such as face 1, face 2, . . . face n. Trajectories refer to the movement of a detected facial image as it appears in the video stream, for example, different x-y coordinates on a video frame. An audio signature or audio feature in the audio stream with each face, is also mapped or identified with each face trajectory and identification. Face trajectory, identification, and audio signature are referred to as a “multimedia signature.” When a facial image changes in the video stream, a new trajectory is started for that facial image.

When it is determined that a commercial may have started, the face trajectories, their identifications, and associated audio signatures cumulatively referred to as multimedia signatures are identified from that commercial segment. The multimedia signature is then searched for in a commercial database. The commercial database contains a compilation of multimedia signatures that are determined to be commercials. If the multimedia signature is found in the commercial database, that segment is confirmed to contain a commercial. If the multimedia signature is not found in the commercial database, a probable commercial signatures database is searched. The probable commercial signatures database includes a compilation of multimedia signatures that are determined as possibly belonging to commercials. If the multimedia signature is found in the probable commercial signatures database, the multimedia signature is added to the commercial database and the multimedia signature is determined to belong to a commercial, thus confirming the segment being analyzed as a commercial.

Thus, when it is determined that a commercial has possibly started by comparing the segment to previous segments, a multimedia signature associated with the segment may be identified in the commercial database. If the multimedia signature exists in the commercial database, the segment is marked as a commercial. If the multimedia signature does not exist in the commercial database, the probable commercial signatures database is searched. If the multimedia signature exists in the probable commercial signatures database, the multimedia signature is added to the commercial database. In sum, multimedia signatures that occur in repetition are promoted to the commercial database, as being commercials.

In another aspect, to further enhance the commercial detection method described above, a sound signature analysis may additionally be employed to verify the commercials detected using facial image detection techniques. That is, after a commercial portion is detected using one or more image recognition techniques, a speech analysis tool may be utilized to verify that voices in the video segments have changed as well, further confirming a change in a program content.

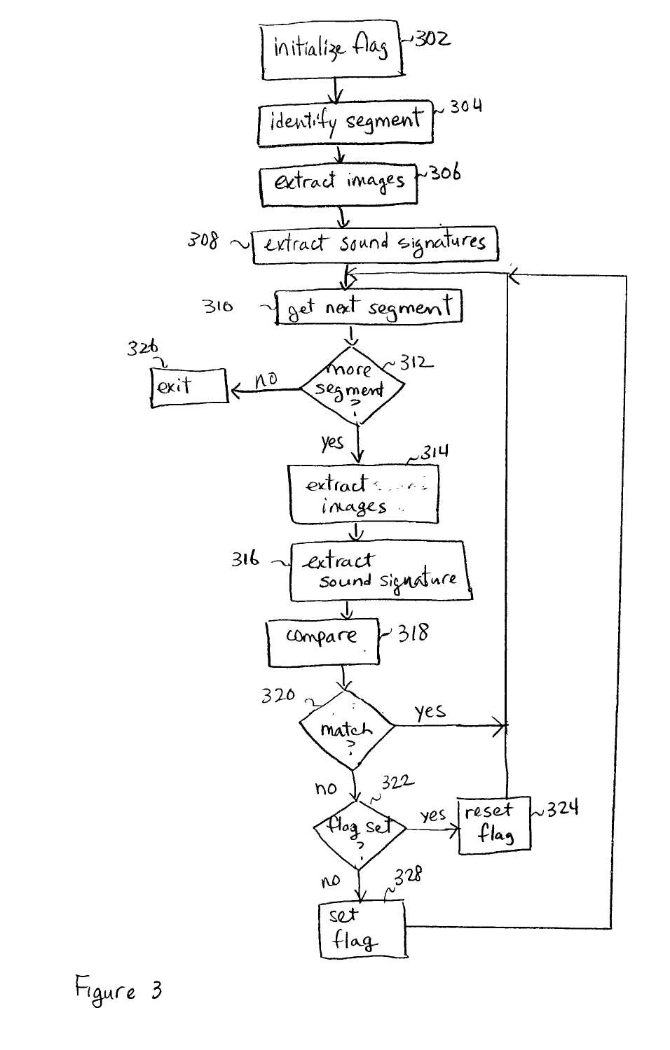

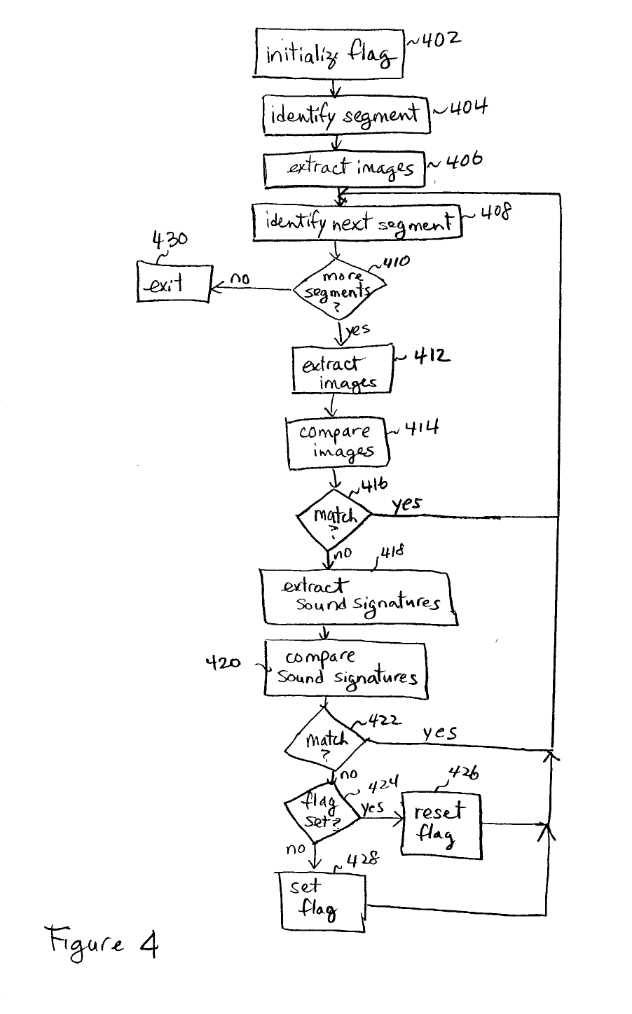

Alternatively, both a facial image detection and a sound signature techniques may be utilized to detect commercials. That is, for each video segment, both the facial images and sound signatures may be compared to those of the previous time window or windows. Only when both facial images and sound signatures mismatch, the commercial flag would be set or reset to indicate a change in the program. These aspects are described in detailed with reference to FIGS. 3 and 4.

FIG. 3 is a flow diagram illustrating the commercial detection method enhanced with sound signature analysis technique. At 302, the commercial flag is initialized. At 304, a segment in the stored content is identified for analysis. At 306, facial images are detected and extracted from this segment. At 308, sound signatures are detected and extracted from this segment. At 310, a subsequent segment in the stored content is identified. At 312, if there is no subsequent segment, indicating the end of the stored content, the process exits at 326. Otherwise, at 314, facial images are detected and extracted in the subsequent segment. Similarly, at 316, sound signature in this subsequent segment is detected and analyzed. At 318, both the facial images and sound signatures detected and extracted in this subsequent segment are compared with those extracted from the previous segment, that is, those extracted at 306 and 308.

At 320, if the facial images and sound signatures do not match, an occurrence of a change in the stored content is detected, for example, from a regular program to a commercial, or vice versa. Accordingly, at 322, it is determined whether the commercial flag is set. The commercial flag indicates what mode the program was in previous to the change. At 322, if the commercial flag is set, the flag is reset at 324, to indicate the program has changed from commercial portion to a regular program portion. Thus, the commercial flag being reset indicates the end of the commercial portion. Otherwise, at 322, if the commercial flag is not set, at 328, the commercial flag is set to indicate that a commercial portion has started. Once the commercial portion is detected in the stored content, the locations of these video segments may be identified and saved for a later reference. Or, if the storage content, for example, on a magnetic tape is being re-taped onto another tape or storage device, this portion may be deleted by skipping to copy this detected commercial portion. The process then returns to 310 where, next segment is analyzed in the same manner.

In another aspect, the sound signature may be analyzed after it is determined that the detected facial images do not match. Thus, in this aspect, the sound signatures are not detected or extracted for every segment. FIG. 4 is a flow diagram illustrating this aspect of the commercial detection. At 402, commercial flag is initialized. At 404, a segment is identified to begin the commercial detection. At 406, facial images are detected and extracted. At 408, next segment is identified. If at 410, an end of the tape is encountered, the process exits at 430. Otherwise, at 412, the process resumes to detect and extract facial images in this next segment. At 414, the images are compared. If the images from the previous segment or time window match with the images extracted at 412, the process resumes to 408. On the other hand, if the images do not match, sound signatures are extracted, both from the previous segment and the current segment at 418. At 420, the sound signatures are compared. If at 422, the sound signatures match, the process resumes to 408. Otherwise, at 424, it is determined whether the commercial flag is set. If the commercial flag is set, the flag is reset at 426, and the process resumes to 408. If at 424, the commercial flag is not set, the flag is set at 428, and the process resumes to 408.

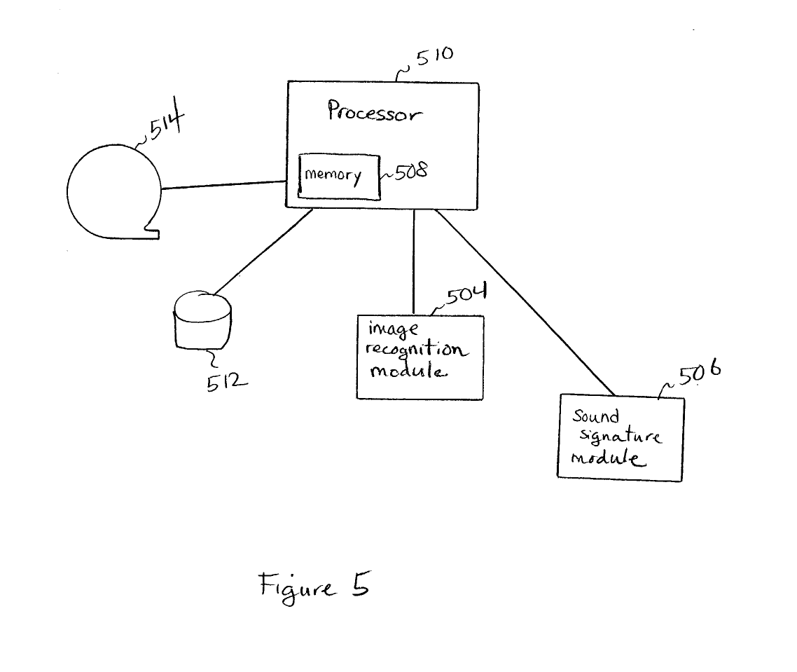

The commercial detection system and method described may be implemented with a general purpose computer. FIG. 5, for example, is a diagram illustrating the components of the commercial detection system in one aspect. A general purpose computer, for example, includes a processor 510, a memory such as a random access memory (“RAM”), an external storage devices 514, and may be connected to an internal or remote database 512. An image recognition module 504 and sound signature module 506, typically controlled by the processor 510, detects and extracts images and sound signatures, respectively. The memory 508, such as a random access memory (“RAM”) is used to load programs and data during the processing. The processor 510 accesses the database 512 and the tape 514, and executes the image recognition module 504 and the sound signature module 506 to detect commercials as described with references to FIGS. 1-4.

The image recognition module 504 may be in a form of software, or embedded into the hardware of a controller or the processor 510. The image recognition module 504 processes the images of each time window, also referred to as video segment. The images may be raw RGB format. The images may also comprise of pixel data, for example. Image recognition techniques for such images are well known in the art and, for convenience, their description will be omitted except to the extent necessary to describe the invention.

The image recognition module 504 may be used, for example, to recognize the contours of a human body in the image, thus recognizing the person in the image. Once the person's body is located, the image recognition module 504 may be used to locate the person's face in the received image and to identify the person.

For example, a series of images are received, the image recognition module 504 may detect and track a person and, in particular, may detect and track the approximate location of the person's head. Such a detection and tracking technique is described in more detail in “Tracking Faces” by McKenna and Gong, Proceedings of the Second International Conference on Automatic Face and Gesture Recognition, Killington, Vt., Oct. 14-16, 1996, pp. 271-276, the contents of which are hereby incorporated by reference. (Section 2 of the aforementioned paper describes tracking of multiple motions.)

For face detection, the processor 510 may identify a static face in an image using known techniques that apply simple shape information (for example, an ellipse fitting or eigen-silhouettes) to conform to the contour in the image. Other structure of the face may be used in the identification (such as the nose, eyes, etc.), the symmetry of the face and typical skin tones. A more complex modeling technique uses photometric representations that model faces as points in large multi-dimensional hyperspaces, where the spatial arrangement of facial features are encoded within a holistic representation of the internal structure of the face. Face detection is achieved by classifying patches in the image as either “face” or “non-face” vectors, for example, by determining a probability density estimate by comparing the patches with models of faces for a particular sub-space of the image hyperspace. This and other face detection techniques are described in more detail in the aforementioned Tracking Faces paper.

Face detection may alternatively be achieved by training a neural network supported within the image recognition module 504 to detect frontal or near-frontal views. The network may be trained using many face images. The training images are scaled and masked to focus, for example, on a standard oval portion centered on the face images. A number of known techniques for equalizing the light intensity of the training images may be applied. The training may be expanded by adjusting the scale of the training face images and the rotation of the face images (thus training the network to accommodate the pose of the image). The training may also involve back-propagation of false-positive non-face patterns. A control unit may provide portions of the image to such a trained neural network routine in the image recognition module 504. The neural network processes the image portion and determines whether it is a face image based on its image training.

The neural network technique of face detection is also described in more detail in the aforementioned Tracking Faces paper. Additional details of face detection (as well as detection of other facial sub-classifications, such as gender, ethnicity and pose) using a neural network is described in “Mixture of Experts for Classification of Gender, Ethnic Origin and Pose of Human Faces” by Gutta, et al., IEEE Transactions on Neural Networks, vol. 11, no. 4, pp. 948-960 (July 2000), the contents of which are hereby incorporated by reference and referred to below as the “Mixture of Experts” paper.

Once a face is detected in the image, the face image is compared with that detected in the previous time window. The neural network technique of face detection described above may be adapted for identification by training the network of matching faces from one time window to a subsequent time window. Faces of other persons may be used in the training as negative matches (for example, false-positive indications). Thus, a determination by the neural network that a portion of the image contains a face image will be based on a training image for a face identified in the previous time window. Alternatively, where a face is detected in the image using a technique other than a neural network (such as that described above), the neural network procedure may be used to confirm detection of a face.

As another alternative technique of face recognition and processing that may be programmed in the image recognition module 504, U.S. Pat. No. 5,835,616, “FACE DETECTION USING TEMPLATES” of Lobo et al, issued Nov. 10, 1998, hereby incorporated by reference herein, presents a two step process for automatically detecting and/or identifying a human face in a digitized image, and for confirming the existence of the face by examining facial features. Thus, the technique of Lobo may be used in lieu of, or as a supplement to, the face detection provided by the neural network technique. The system of Lobo et al is particularly well suited for detecting one or more faces within a camera's field of view, even though the view may not correspond to a typical position of a face within an image. Thus, the image recognition module 504 may analyze portions of the image for an area having the general characteristics of a face, based on the location of flesh tones, the location of non-flesh tones corresponding to eye brows, demarcation lines corresponding to chins, nose, and so on, as in the referenced U.S. Pat. No. 5,835,616.

If a face is detected in one time window, it is characterized for comparison with a face detected from a previous time window, which may be stored in a database. This characterization of the face in the image is preferably the same characterization process that is used to characterize the reference faces, and facilitates a comparison of faces based on characteristics, rather than an ‘optical’ match, thereby obviating the need to have two identical images (current face and reference face, the reference face being detected in the previous time window) in order to locate a match.

Thus, the memory 508 and/or the image recognition module 504 effectively includes a pool of images identified in the previous time window. Using the images detected in the current time window, the image recognition module 504 effectively determines any matching images in the pool of reference images. The “match” may be detection of a face in the image provided by a neural network trained using the pool of reference images, or the matching of facial characteristics in the camera image and reference images as in U.S. Pat. No. 5,835,616, as described above.

The image recognition processing may also detect gestures in addition to the facial images. Gestures detected in one time window may be compared with those detected in the subsequent time window. Further details on recognition of gestures from images are found in “Hand Gesture Recognition Using Ensembles Of Radial Basis Function (RBF) Networks And Decision Trees” by Gutta, Imam and Wechsler, Int'l Journal of Pattern Recognition and Artificial Intelligence, vol. 11, no. 6, pp. 845-872 (1997), the contents of which are hereby incorporated by reference.

A sound signature module 506, for example, may utilize any one of known speaker identification techniques commonly used. These techniques include, but are not limited to, standard sound analysis techniques that employ matching of features like LPC coefficients, zero-cross over rate, pitch, amplitude, etc. “Classification of General Audio Data for Content-Based Retrieval” by Dongg Li, Ishwar K. Sethi, Nevenka Dimitrova, Tom McGee, Pattern Recognition Letters 22 (2001) 533-544, the contents of which are hereby incorporated by reference, describes various methods of extracting and identifying audio patterns. Any of the speech recognition techniques described in this article, such as various audio classification schemes including Gaussian model-based classifiers, neural network-based classifiers, decision trees, and the hidden Markov model-based classifiers, may be employed to extract and identify different voices. Further audio toolbox for feature extraction described in the article may also be used to identify different voices in the video segments. The identified voices are then compared from segment to segment to detect changes in the voice pattern. When a change in a voice pattern is detected from one segment to another, a change in the program content, for example, to a commercial from a regular program, may be confirmed.

While the invention has been described with reference to several embodiments, it will be understood by those skilled in the art that the invention is not limited to the specific forms shown and described. For example, while the image detection, extraction, and comparison have been described with respect to facial images, it will be understood that other images rather than facial images or in addition to facial images may be used to differentiate and detect commercial portions. Thus, various changes in form and details may be made therein without departing from the spirit and scope of the invention as defined by the appended claims.

What is claimed is:

1. A method for detecting commercials in a stored content, comprising:
identifying a plurality of video segments in a stored content;
detecting a first one or more images in a first one of the plurality of video segments;
detecting a second one or more images in a second one of the plurality of video segments;
comparing the second one or more images with the first one or more images;
if none of the second one or more images match with the first one or more images,
comparing one or more sound signatures detected in the first one of the plurality of video segments and the second one of the plurality of video segments; and
if the sound signatures in the first one of the plurality of video segments and the second one of the plurality of video segments do not match, setting a flag indicating a beginning of a commercial portion.

2. The method of claim 1, wherein the identifying includes identifying a plurality of segments in consecutive time order.

3. The method of claim 1, wherein the first one of the plurality of video segments and the second one of the plurality of video segments are in order of time sequence.

4. The method of claim 1, wherein the first one of the plurality of video segments precedes the second one of the plurality of video segments.

5. The method of claim 1, the detecting a first one or more images further includes extracting the first one or more images and the detecting a second one or more images further includes extracting the second or more images.

6. The method of claim 1, further including:
detecting sound signatures in the first one of the plurality of video segments and the second one of the plurality of video segments.

7. The method of claim 1, wherein the first and the second one or more images include one or more facial images.

8. The method of claim 1, wherein the first and the second one or more images include one or more facial characteristics.

9. The method of claim 1, wherein the first and the second one or more images include one or more gestures.

10. A program storage device readable by a machine, tangibly embodying a program of instructions executable by the machine to perform method steps of detecting commercials in a stored content, comprising:
identifying a plurality of video segments in a stored content;
detecting a first one or more images in a first one of the plurality of video segments;
detecting a second one or more images in a second one of the plurality of video segments;
comparing the second one or more images with the first one or more images;
if none of the second one or more images match with the first one or more images,
comparing one or more sound signatures detected in the first one of the plurality of video segments and the second one of the plurality of video segments; and
if the sound signatures in the first one of the plurality of video segments and the second one of the plurality of video segments do not match, setting a flag indicating a beginning of a commercial portion.

11. A system for detecting commercials in a stored content, comprising:
an image recognition module that detects one or more images in a plurality of video segments;
a sound analysis module that detects one or more sound signatures in the plurality of video segments; and
a processor that identifies the plurality of video segments and executes the image recognition module and the sound analysis module to detect, extract, and compare one or more images and sound signatures in the plurality of video segments.

12. A method for detecting commercials in a stored content, comprising:
identifying a plurality of video segments in a stored content;
detecting first one or more images from one of the plurality of video segments;
comparing the first one or more images with one or more images extracted from a predetermined number of video segments preceding the one of the plurality of video segments;
if the first one or more images do not match with the one or more images extracted from the predetermined number of video segments preceding the one of the plurality of video segments,
comparing first one or more sound signatures detected in the first one of the plurality of video segments with one or more sound signatures extracted from the predetermined number of video segments preceding the one of the plurality of video segments; and
if the sound signatures do not match, setting a flag indicating a beginning of a commercial portion.

13. A method for detecting commercials in a stored content, comprising:
identifying a plurality of video segments in a stored content;
detecting a first one or more images in a first one of the plurality of video segments;
detecting a second one or more images in a second one of the plurality of video segments;
comparing the second one or more images with the first one or more images; and
if none of the second one or more images match with the first one or more images, setting a flag indicating a beginning of a commercial portion.
